(19) United States
(12) Patent Application Publication
(10) Pub. No.: US 2019/0121014 A1
(43) Pub. Date: Apr. 25, 2019

(54) LIGHT GUIDE PLATE AND FABRICATION THEREOF AND LIGHT SOURCE MODULE HAVING THE SAME

(71) Applicant: Lextar Electronics Corporation, Hsinchu (TW)

(72) Inventors: Teng-Huei HUANG, Hsinchu County (TW); I-Chang TSAO, Hsinchu City (TW); Cheng-Ta KUO, Hsinchu City (TW); Jhih-Han LIN, Hsinchu County (TW); Wei-Jung CHANG, New Taipei City (TW); Sheng-Ju CHUNG, Taoyuan City (TW); Li-Li LIU, Jiangsu Province (CN); Wen ZHOU, Hunan Province (CN)

(21) Appl. No.: 15/791,429

(22) Filed: Oct. 24, 2017

(51) Int. Cl. F21V 8/00; B29C 33/42

(52) U.S. Cl. CPC G02B 6/0036; B29C 33/42; G02B 6/0088; G02B 6/0065; G02B 6/0068

(57) ABSTRACT

A light guide plate includes a light-transmissive substrate and at least one microstructure. The light-transmissive substrate includes first and second major surfaces and a side surface connecting the first and second major surfaces. The microstructure is formed on the first major surface. The microstructure comprises a recess and an annular groove around the recess. The annular groove has a depth greater than a depth of the recess. A bottom of the recess is at higher elevation than the first major surface from the second major surface.

### BACKGROUND

### Technical Field

Embodiments of the present disclosure relate to a light guide plate.

### Description of Related Art

In a typical display device, a display panel device relies on a backlight module powered by electricity to display images. Currently, backlight modules can be classified as either an edge lighting type or a direct lighting type depending upon the location of lamps within the device. The backlight module includes a light guide plate and a light source that provides light to the light guide plate.

### SUMMARY

According to some embodiments, a light guide plate includes a light-transmissive substrate and at least one microstructure. The light-transmissive substrate includes first and second major surfaces and a side surface connecting the first and second major surfaces. The microstructure is formed on the first major surface. The microstructure comprises a recess and an annular groove around the recess. The annular groove has a depth greater than a depth of the recess. A bottom of the recess is at higher elevation than the first major surface from the second major surface.

According to some embodiments, a method of stamping on light guide plate includes following steps. A first microstructure is formed on a surface of a mold core using laser processing. The first microstructure includes a first recess with a smooth surface area not less than half a total surface area of the first recess, and a ring around the first recess and protruding from the surface of the mold core. A light guide plate is thermoformed using the mold core with the first microstructure.

According to some embodiments, a light source module includes a light source and a light guide plate optically coupled to the light source. The light guide plate includes a light-transmissive substrate and a microstructure. The light-transmissive substrate includes first and second major surfaces and a side surface connecting the first and second major surfaces. The microstructure is formed on the first major surface. The microstructure includes a recess and an annular groove around the recess. The annular groove has a depth greater than a depth of the recess. The bottom of the recess is at higher elevation than the first major surface from the second major surface.

Embodiments of the present disclosure offer advantages, though it is understood that other embodiments may offer different advantages, not all advantages are necessarily discussed herein, and no particular advantage is required for all embodiments. For example, embodiments discussed herein are directed to a light guide plate having one or more microstructures with suitable geometries that are advantageous for providing a desired light distribution to a display panel.

It is to be understood that both the foregoing general description and the following detailed description are by examples, and are intended to provide further explanation of the disclosure as claimed.

### BRIEF DESCRIPTION OF THE DRAWINGS

Embodiments of the present disclosure can be more fully understood by reading the following detailed description of the embodiments, with reference made to the accompanying drawings as follows.

FIG. 1 is a cross-sectional view of a light guide plate in accordance with some embodiments of the present disclosure.

FIG. 2 is an enlarged view of one microstructure shown in FIG. 1.

FIG. 3 is an enlarged fragmentary view of a mold core that implements fabrication of the light guide plate in accordance with some embodiments of the present disclosure.

FIG. 4 is a top view of a light guide plate in accordance with some embodiments of the present disclosure.

FIG. 5 is a top view of a light guide plate in accordance with some embodiments of the present disclosure.

FIG. 6 is a cross-sectional view of an edge light source module in accordance with some embodiments of the present disclosure.

FIG. 7 is a cross-sectional view of a direct back light source module in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

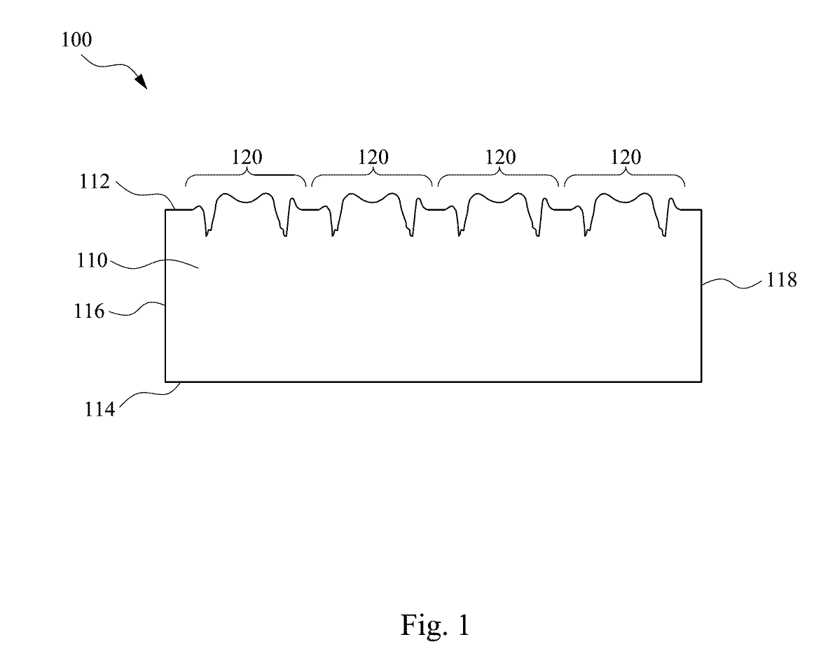

FIG. 1 is a cross-sectional view of a light guide plate 100 in accordance with some embodiments of the present disclosure. As illustrated, the light guide plate 100 includes a light-transmissive substrate 110 having first and second major surfaces 112, 114 and side surfaces 116, 118. The side surface 116 connects a first side (e.g., left side as illustrated) of the first major surface 112 and a first side (e.g., left side as illustrated) of the second major surface 114. The side surface 118 connects a second side (e.g., right side as illustrated) of the first major surface 112 and a second side (e.g., right side as illustrated) of the second major surface 114. The light guide plate 100 further includes one or more microstructures 120 formed on the first major surface 112. In the illustration, these microstructures 120 have different cross-sectional contours than that of the smooth first major surface 112, and hence the microstructures 120 may scatter light traveling there-through, which in turn will provide a desired light distribution to a display panel (not shown) disposed over the light guide plate 100.

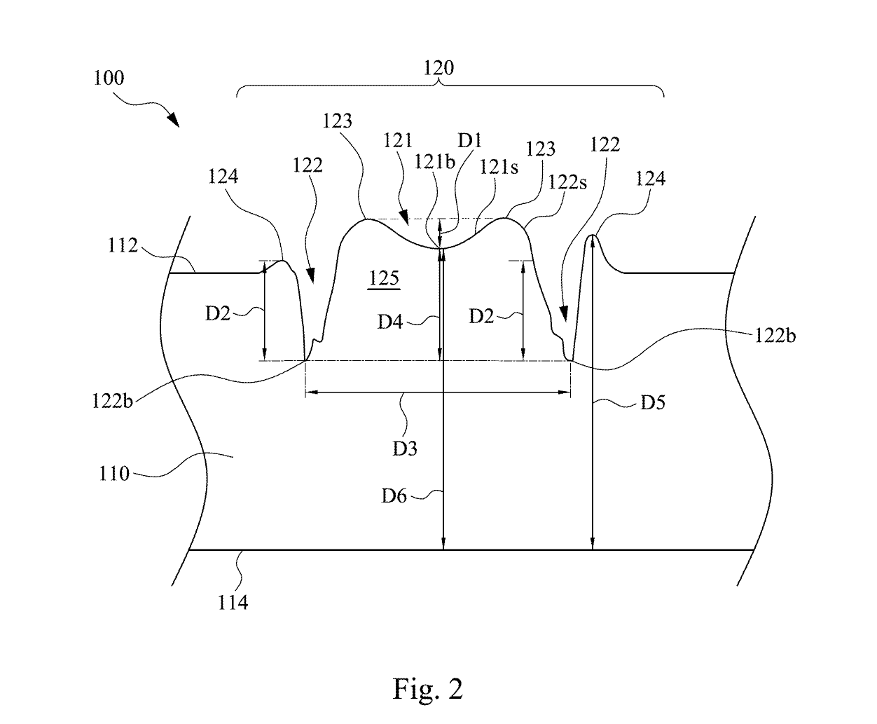

Referring to FIG. 2, illustrated is an enlarged view of a microstructure 120 shown in FIG. 1. The microstructure 120 includes a recess 121 and an annular groove 122 around (i.e., encircling) the recess 121. The annular groove 122 is deeper than the recess 121. For example, the recess 121 has a depth D1 measured along a vertical direction (e.g., a direction from the first major surface 112 to the second major surface 114), the annular groove 122 has a depth D2 measured along the vertical direction, and the depth D2 of the annular groove 122 is greater than the depth D1 of the recess 121. Moreover, a bottom 121b of the recess 121 is at a position higher than the first major surface 112. Stated in another way, the bottom 121b of the recess 121 is at higher elevation than the first major surface 112 from the second major surface 114. Such geometry as discussed above may be advantageous to achieve a desired light distribution.

Moreover, in some embodiments, a bottom 122b of the annular groove 122 is at a position lower than the bottom 121b of the recess 121. In other words, the bottom 121b of the recess 121 is at higher elevation than the bottom 122b of the annular groove 122 from the second major surface 114. In further embodiments, the bottom 122b of the annular groove 122 is at a position lower than the first major surface 112. Stated differently, the bottom 122b of the annular groove 122 is at lower elevation than the first major surface 112 from the second major surface 114.

In some embodiments, the bottom 122b of the annular groove 122 is curved more than the recess 121. For example, the bottom 122b of the annular groove 122 has curvature greater than the recess 121. Stated in another way, the bottom 122b of the annular groove 122 has a curvature radius less than a curvature radius of the recess 121.

In some embodiments, the microstructure 120 further includes a convex surface 123 around the recess 121. The convex surface 123 protrudes in a direction away from the second major surface 114 and extends in a circular direction to encircle the recess 121. The convex surface 123 is at higher elevation than the first major surface 112 from the second major surface 114. The convex surface 123 connects a sidewall 121s of the recess 121 and a sidewall 122s of the annular groove 122. The convex surface 123 has a smooth convex contour in a cross-sectional view as illustrated in FIG. 1, which indicates that a top of the convex surface 123 has a zero slope. In some embodiments, the recess 122 has a smooth concave contour in a cross-sectional view as illustrated in FIG. 1, which indicates that the bottom 121b of the recess 121 has a zero slope.

In some embodiments, the microstructure 120 further includes a protrusion 124 around the annular groove 122. The protrusion 124 protrudes in a direction substantially the same as that the convex surface 123 protrudes in. For example, the protrusion 124 protrudes in the direction away from the second major surface 114 and extends in a circular direction to encircle the annular groove 122. Thus, the protrusion 124 connects the annular groove 122 and the first major surface 112.

In some embodiments, the protrusion 124 has a smooth convex contour in a cross-sectional view as illustrated in FIG. 2, which indicates that a top of the protrusion 124 has a zero slope. In some embodiments, the protrusion 124 is curved more than the convex surface 123. For example, the protrusion 124 has curvature greater than curvature of the convex surface 123. Stated differently, the protrusion 124 has a curvature radius less than a curvature radius of the convex surface 123.

In some embodiments, the protrusion 124, the annular groove 122, the convex surface 123 and the recess 121 are arranged in a concentric fashion. A structure encircled by the annular groove 122 is also referred to as a spherical protrusion 125 that protrudes from the annular groove 122. The recess 121 is recessed from a top of the spherical protrusion 125.

In some embodiments, the protrusion 124 is at a position higher than the first major surface 112. Stated in another way, the protrusion 124 is at higher elevation than the first major surface 112 from the second major surface 114. In further embodiments, the protrusion 124 is at a position lower than the convex surface 123. In other words, the protrusion 124 is at lower elevation than the convex surface 123 from the second major surface 114.

In some embodiments, the depth D1 of the recess 121 ranges from about 1.5 um to about 2.1 um. For example, the depth D1 of the recess 121 is about 1.8 um. In some embodiments, the depth D2 of the annular groove 122 ranges from about 2.5 um to about 3.5 um. For example, the depth D2 of the annular groove 122 is about 3 um. In some embodiments, two bottoms 122b of the annular groove 122 geometrically farthest away from each other are separated by a distance D3, which is in a range from about 50 um to about 65 um. For example, the distance D3 separating opposite bottoms 122b of the annular groove is about 57 um. In some embodiments, the bottom 121b of the recess 121 and the bottom 122b of the annular groove 122 are separated by a vertical distance D4, which is in a range from about 2.5 um to about 3.7 um. For example, the vertical distance D4 separating bottoms 121b and 122b of the recess 121 and annular groove 122 is about 3.1 um. In some embodiments, the top of the protrusion 124 and the second major surface 114 are separated by a vertical distance D5, which is in a range from about 1.981 mm to about 2.021 mm. For example, the vertical distance D5 separating the top of the protrusion 124 and the second major surface 114 is about 2.001 mm. In some embodiments, the bottom 121b of the recess 121 and the second major surface 114 are separated by a vertical distance D6, which is in a range from about 1.981 mm to about 2.021 mm. For example, the vertical distance D6 separating the bottom 121b of the recess 121 and the second major surface 114 is about 2.001 mm.

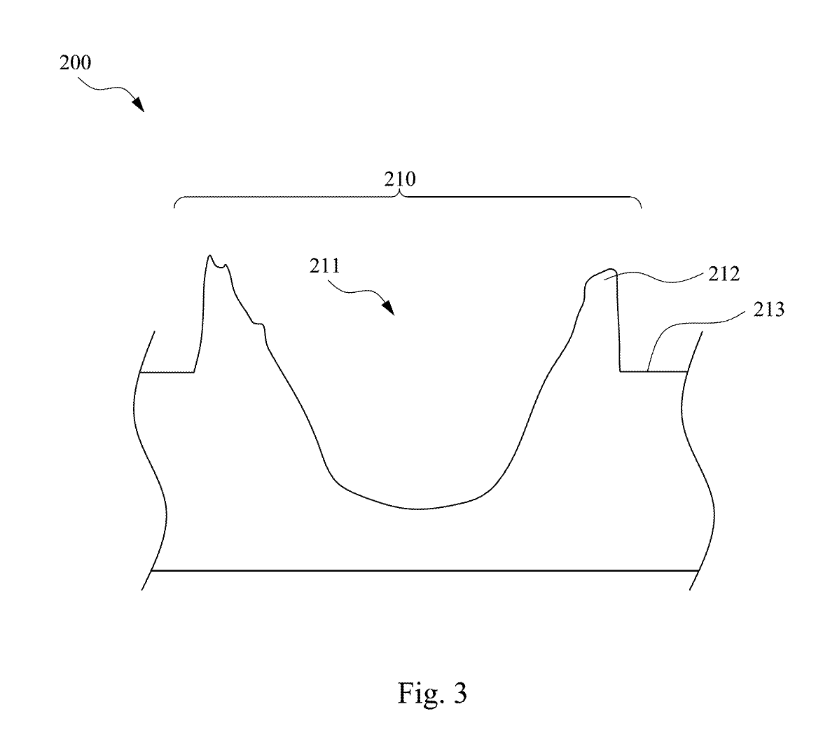

One or more geometries of the microstructure 120 as discussed above are advantageous for achieving a desired light distribution provided by light guide plate 100. Fabrication of the light guide plate 100 having one or more microstructures 120 as discussed above is described below with reference to FIG. 3, which illustrates an enlarged fragmentary view of a mold core 200 that implements the fabrication of the light guide plate 100. Formation of the mold core 200 includes forming one or more microstructures 210 on a surface 213 of the mold core 200 using a laser process. The microstructure 210 has a recess 211 and a ring 212 around the recess 211 and protruding from the surface 213 of the mold core 200. The recess 211 has a smooth surface not less than half a total surface of the recess 211. The light guide plate 100 can be thermoformed using the mold core 200 with the one or more microstructures 210. Conditions of the thermoforming process using the mold core 200 with the microstructure(s) 210 is advantageous for forming the light guide plate 100 with the microstructure(s) 120 with desired geometry as discussed above by using a thermoforming process. As a result, the light guide plate 100 capable of generating a desired light distribution can be fabricated using the mold core 200. In some embodiments, the thermoforming process is performed at a temperature in a range from about 50 degrees Celsius to about 150 degrees Celsius. If the thermoforming process is performed at a temperature higher than 150 degrees Celsius, the cooling time will increase even cause the light guide plate curved during cooling process. If the thermoforming process is performed at a temperature lower than 50 degrees Celsius, the microstructure is unable to stamp to the surface of the light guide plate.

For example, the laser process for forming the microstructure 210 is carried out via a neodymium-doped yttrium aluminum garnet laser (Nd-YAG) or the like. The wavelength of the laser ranges from about 900 nanometers to about 1800 nanometers. The laser is focused on the mold core 200, rapidly increasing a temperature of the focus point. As a result, the mold core 200 material at the focus point disintegrates due to high temperature oxidation, thus forming the spherical recess 211. During the laser process, the mold core 200 material around the focus point is melted, which in turn forms the ring 212 enclosing the spherical recess 211.

After formation of the mold core 200, the light guide plate 100 can be molded in a mold having the mold core 200 using a thermoforming process. The spherical protrusion 125 is formed on the light guide plate 100 corresponding to the spherical recess 211 of the mold core 200, and the annular groove 122 are defined in the light guide plate 100 corresponding to the ring 212 of the mold core 200. The recess 121 of the spherical protrusion 125 may be formed because of air gap between the mold core 200 and the material of the light guide plate 100 during the thermoforming process.

The light guide plate 100 may be made from a material such as polycarbonate, polymethyl methacrylate, polystyrene, copolymer of methylmethacrylate and styrene, the like, or combinations thereof. In alternative embodiments, the laser process may be implemented by ruby laser, alexandrite laser, and so on. The wavelength of the laser may also be selected from other desired values, such as 266 nanometers, 355 nanometers, 532 nanometers, and so on.

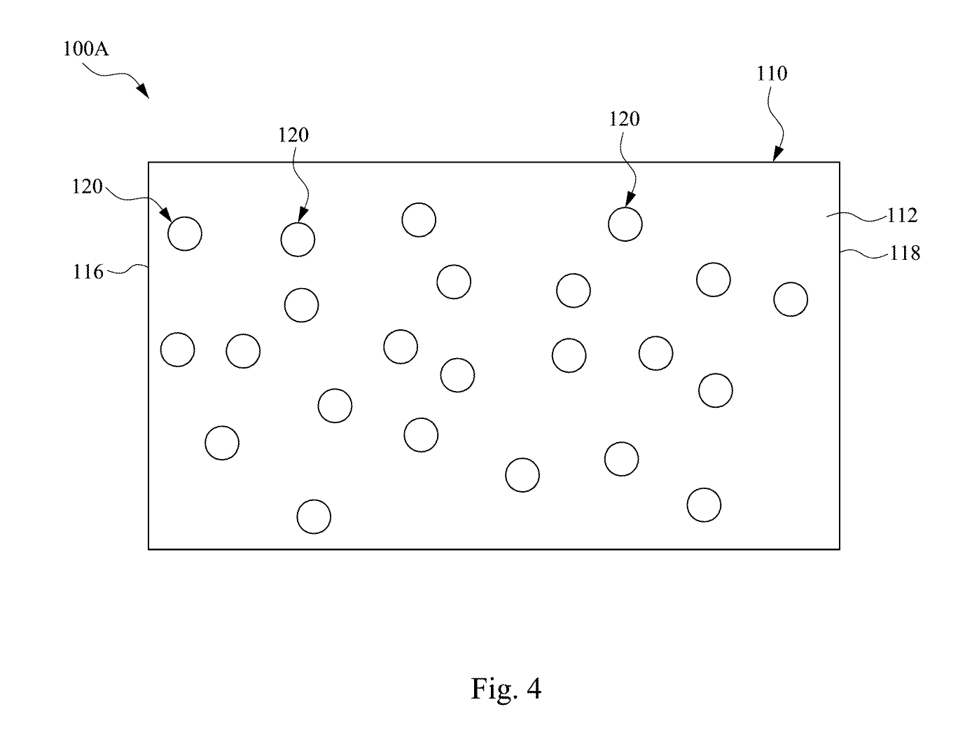

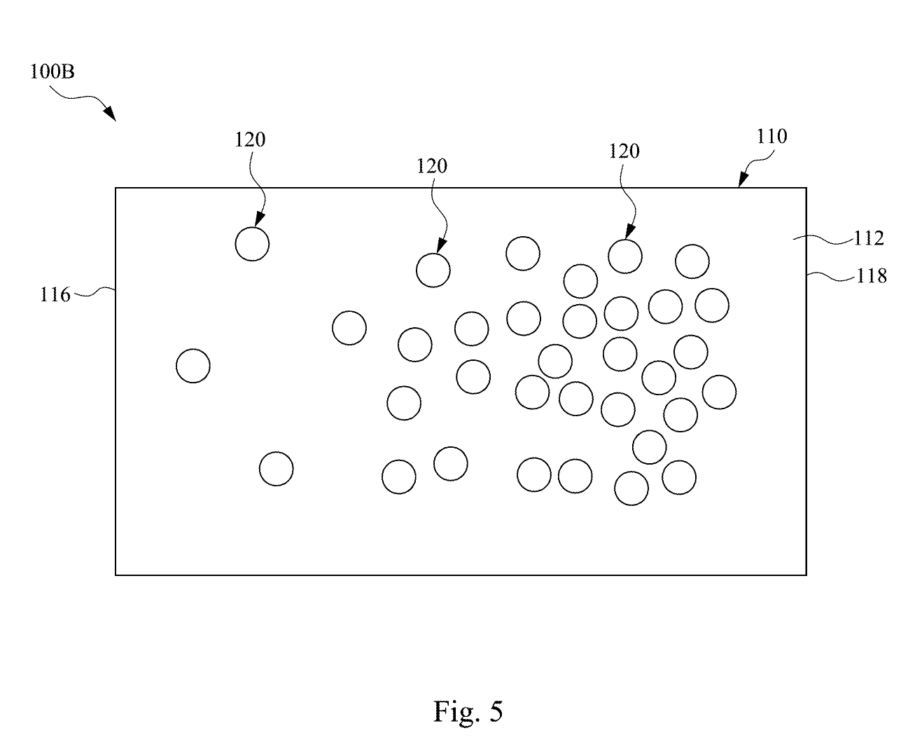

Microstructures 120 can be distributed in various fashions. For example, referring now to FIG. 4, illustrated is a light guide plate 100A including numerous microstructures 120 distributed on the first major surface 112 of the light-transmissive substrate 110 in a random order. Stated in another way, a distance between any neighboring two microstructures 120 is irregular rather than following a regular order. Referring now to FIG. 5, illustrated is another light guide plate 100B including numerous microstructures 120 distributed in a different fashion than that of the light guide plate 100A. For example, the microstructures 120 are distributed as a function of a distance from one side surface (e.g., the side surface 116) of the light-transmissive substrate 110. Stated differently, the distribution density of the microstructures 120 is related of the distance from the side surface 116. In further embodiments, as illustrated in FIG. 5, the distribution density of the microstructures 120 increases as a distance increases from the side surface 116. Such a distribution of microstructures 120 may be beneficial in providing more uniform light distribution, if the light guide plate 100B is employed in an edge-type back light module where a light source is disposed proximate the side surface 116. This is due to the fact that light flux decreases as a distance from the side surface 116 increases.

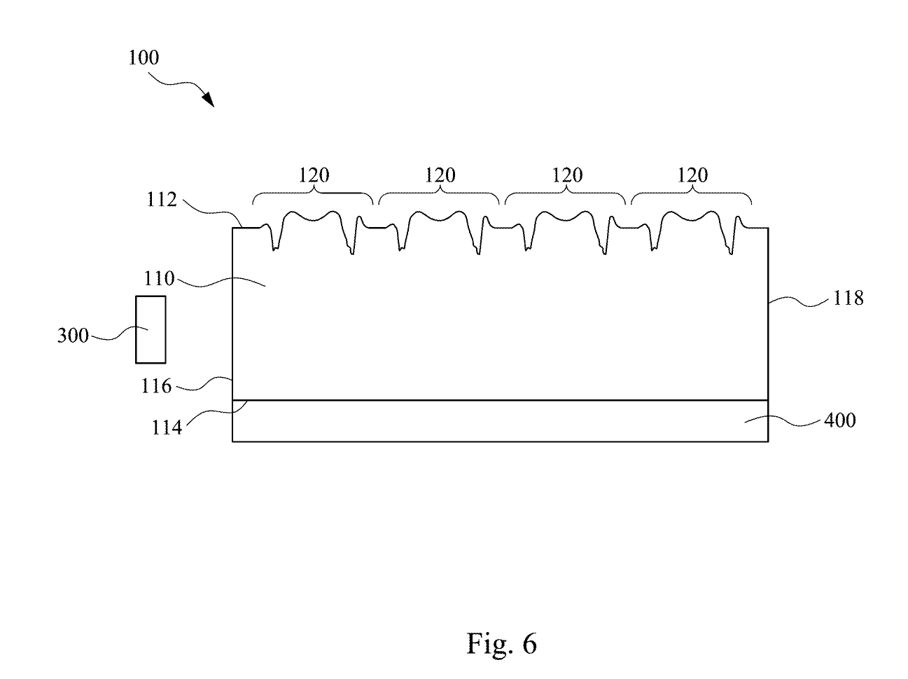

The light guide plate(s) as discussed above can be employed in any of a variety of light source modules. For example, referring to FIG. 6, illustrated is a light source module including the light guide plate 100, a light source 300 and a reflective feature 400. The light guide plate 100 is optically coupled to the light source 300 through the side surface 116. The term “optically coupled” as used herein refers to coupling such that light from one element is imparted to another element. In the illustration, the light source 300 is disposed adjacent to the side surface 116 of the light-transmissive substrate 110, and the reflective feature 400 is disposed adjacent to the second major surface 114 of the light-transmissive substrate 110. In this way, the light source 300 can emit light into the light guide plate 100 through the side surface 116, and the light traveling within the light guide plate 100 can be reflected toward the microstructures 120 by the reflective feature 400. Thus, the microstructures 120 can scatter the light toward an overlying display panel (not shown). In this case, the light source module as illustrated in FIG. 6 can be equivalently referred to as an edge-type back light module. In some embodiments, the microstructures 120 are upright over the reflective feature 400, which in turn will benefit scattering the light. In some embodiments, an additional reflective feature (not shown) is disposed adjacent to the side surface 118 to confine light in the light guide plate 100. In some embodiments, a light guide plate according to other embodiments (e.g., the light guide plate 100A or 100B) can be employed in place of the light guide plate 100.

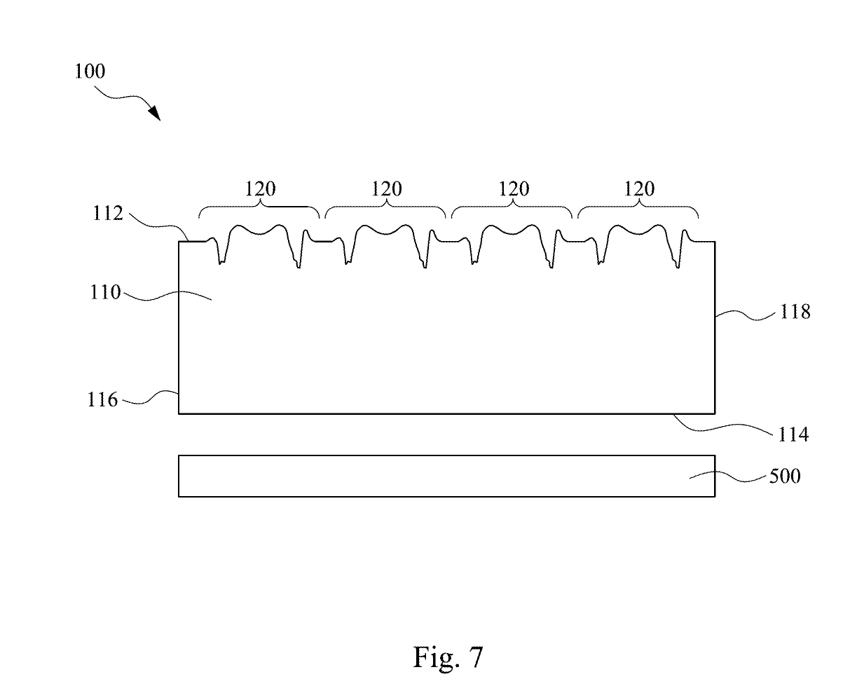

Referring to FIG. 7, illustrated is another light source module different from the light source module illustrated in FIG. 6. The light source module as illustrated in FIG. 7 includes the light guide plate 100 and a light source 500 disposed adjacent to the second major surface 114 of the light-transmissive substrate 110. For example, the second major surface 114 is between the light source 500 and the microstructures 120. In this way, the light emitted from the light source 500 travels into the light-transmissive substrate 110 and toward the microstructures 120 through the second major surface 114. Thus, the microstructures 120 can scatter the light toward an overlying display panel (not shown). In this case, the light source module as illustrated in FIG. 7 can serve as either an illumination module or a direct-type backlight module. In some embodiments, additional reflective features (not shown) are respectively disposed adjacent to the side surfaces 116 and 118 to confine light in the light guide plate 100. In some embodiments, a light guide plate according to other embodiments (e.g., the light guide plate 100A or 100B) can be employed in place of the light guide plate 100.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A light guide plate, comprising:
a light-transmissive substrate comprising first and second major surfaces and a side surface connecting the first and second major surfaces; and
at least one microstructure formed on the first major surface, wherein the microstructure comprises a recess and an annular groove around the recess, the annular groove has a depth greater than a depth of the recess, and a bottom of the recess is at higher elevation than the first major surface from the second major surface, wherein the annular groove has a protruding portion protruding from a bottom of the annular groove.

2. The light guide plate of claim 1, wherein the bottom of the annular groove is at lower elevation than the first major surface from the second major surface.

3. The light guide plate of claim 1, wherein the bottom of the recess is at higher elevation than the bottom of the annular groove.

4. The light guide plate of claim 1, wherein the bottom of the annular groove has curvature greater than curvature of the recess.

5. The light guide plate of claim 1, wherein the microstructure further comprises a convex surface protruding in a direction away from the second major surface, and the convex surface is at higher elevation than the first major surface from the second major surface.

6. The light guide plate of claim 5, wherein the convex surface connects a sidewall of the recess and a sidewall of the annular groove.

7. The light guide plate of claim 5, wherein the microstructure further comprises a protrusion protruding in the direction away from the second major surface, and the protrusion connects the annular groove and the first major surface.

8. The light guide plate of claim 7, wherein the protrusion is at higher elevation than the first major surface from the second major surface.

9. The light guide plate of claim 8, wherein the protrusion is at lower elevation than the convex surface from the second major surface.

10. The light guide plate of claim 7, wherein the protrusion has curvature greater than curvature of the convex surface.

11. The light guide plate of claim 1, wherein a plurality of the microstructures are distributed on the first major surface in a random order.

12. The light guide plate of claim 1, wherein a distribution density of the microstructures is related of a distance from the side surface.

13. The light guide plate of claim 12, wherein a distribution density of a plurality of the microstructures increases as a distance increases from the side surface.

14. A method of stamping on light guide plate, comprising:
forming a first microstructure on a surface of a mold core using laser processing, the first microstructure comprising a first recess with a smooth surface area not less than half a total surface area of the first recess, and a ring around the first recess and protruding from the surface of the mold core; and
thermoforming a light guide plate using the mold core with the first microstructure.

15. The method of stamping on light guide plate according to claim 14, wherein conditions of the thermoforming are such that the light guide plate is formed with a second microstructure on a first major surface of the light guide plate, the second microstructure has a second recess and an annular groove around the second recess, the annular groove has a depth greater than a depth of the second recess, and a bottom of the second recess is at higher elevation than the first major surface from a second major surface of the light guide plate.

16. The method of stamping on light guide plate according to claim 14, wherein the thermoforming is performed at a temperature in a range from about 50 degrees Celsius to about 150 degrees Celsius.

17. A light source module, comprising:
a light source; and
a light guide plate optically coupled to the light source, the light guide plate comprising:
a light-transmissive substrate comprising first and second major surfaces and a side surface connecting the first and second major surfaces; and
a microstructure formed on the first major surface, wherein the microstructure comprises a recess and an annular groove around the recess, the annular groove has a depth greater than a depth of the recess, and a bottom of the recess is at higher elevation than the first major surface from the second major surface, wherein the annular groove has a protruding portion protruding from a bottom of the annular groove.

18. The light source module of claim 17, wherein the light source is disposed adjacent to the side surface of the light-transmissive substrate.

19. The light source module of claim 17, further comprising:
a reflective feature on the second major surface.

20. The light source module of claim 17, wherein the second major surface is between the light source and the microstructure.
